(19) United States
(12) Patent Application Publication
(10) Pub. No.: US 2013/0282443 A1
(43) Pub. Date: Oct. 24, 2013

(54) SELLER URL MONITORING SYSTEMS AND METHODS

(71) Applicants: Sahib Bal, San Jose, CA (US); Giselle Nevada, Pflugerville, TX (US); Carolina Barcenas, Austin, TX (US)

(72) Inventors: Sahib Bal, San Jose, CA (US); Giselle Nevada, Pflugerville, TX (US); Carolina Barcenas, Austin, TX (US)

(21) Appl. No.: 13/852,984

(22) Filed: Mar. 28, 2013

Related U.S. Application Data
(60) Provisional application No. 61/635,138, filed on Apr. 18, 2012.

(51) Int. Cl. G06Q 10/06

(52) U.S. Cl. CPC G06Q 10/0637
USPC 705/7.36

(57) ABSTRACT

Systems and methods for monitoring seller URLs are described. The methods include receiving a merchant URL associated with a merchant site, extracting content from a Web page associated with the merchant URL, and determining actionable changes related to a payment provider service on the merchant site.

### CROSS REFERENCE TO RELATED APPLICATION

The present application is related to and claims priority to U.S. Provisional Patent Application No. 61/635,138 filed Apr. 18, 2012, which is incorporated by reference in its entirety.

### BACKGROUND

1. Field of the Invention

The invention is directed towards methods and systems for retrieving and analyzing data from merchant or seller websites.

2. Related Art

The Internet contains billions of documents (e.g., Web pages) that are identified by respective uniform resource locators (URLs). Websites contain related Web pages. Web crawlers are applications that download Web pages and index the downloaded Web pages (and respective URLs) according to a particular categorization scheme.

Monitoring websites for changes can be valuable for many businesses. For example, a company website may include a service offered by a service provider. Knowledge of what changes have been made to the website is important to better understand the needs of the company, make better risk predictions, and tailor services accordingly. Thus, a need exists for systems and methods that monitor websites for changes.

### BRIEF DESCRIPTION OF THE FIGURES

FIG. 1 is a block diagram of a networked system suitable for implementing the methods described herein according to an embodiment;

FIG. 2 is a flowchart showing a method of monitoring a merchant URL according to one embodiment; and

FIG. 3 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for monitoring websites, e.g. seller or merchant websites. The seller sites may be ones which utilize a service provider as a payment option on the site. The systems and methods capture information from seller URLs and use that information to monitor them. The monitoring system alerts the service provider when a seller has made changes to their site, for example, a change in the merchandise advertised, prices, Service Agreement, etc. The systems and methods also categorize the associated risk of the change. A “High Risk” involves merchants moving into riskier categories, and alerts can be generated for review or for additional communication with sellers. Models and rules can use the parsed information from the URLs content and determine the risk levels and actions. Each seller's site can then be scored to indicate the quality (e.g., “trustworthiness”, reliability, and legitimacy) of the site.

In a specific embodiment, a merchant URL is automatically monitored by a service provider through Web crawling. Actionable changes related to a service provided by the service provider are then determined. Actionable changes may include the seller removing a payment option from the site, moving the payment option to a less desirable position on the site, reducing the visual size of the payment option on the site, adding new payment options to the site, making other payment option(s) more prominent on the site, such as better placement and/or visibility, etc. When an actionable change is detected, the service provider may contact the merchant for remedial action if needed. Monitoring changes in a seller website enables the service provider to take action at an early stage before a relationship reaches or passes a critical stage, such as the merchant canceling the relationship or partnership with the service provider.

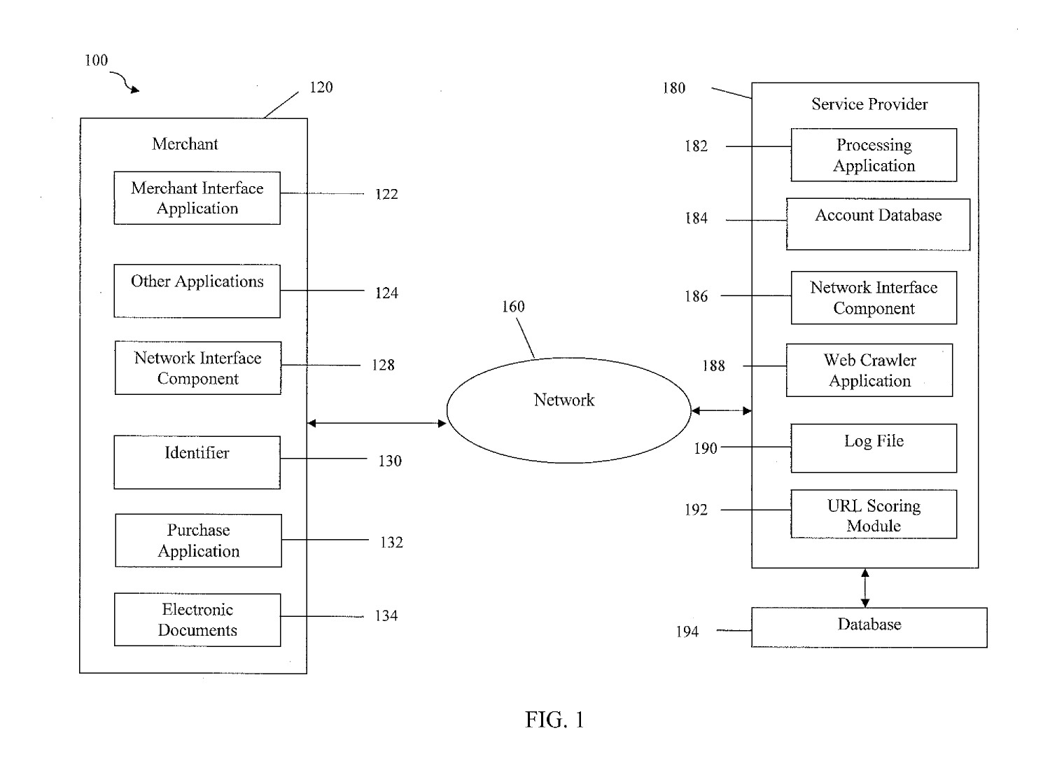

FIG. 1 illustrates an exemplary embodiment of a network-based system 100 for implementing one or more processes described herein over a network 160. As shown, network-based system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a merchant device 120 and a service provider server 180 in communication over the network 160. Service provider server 180 may be maintained by a payment provider, such as PayPal®, Inc. of San Jose, Calif. Although a payment service provider device is shown, the server may be managed or controlled by any suitable service provider. Although only one server is shown, a plurality of servers may be utilized.

Merchant device 120 and service provider server 180 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

Merchant device 120, in various embodiments, may be implemented using any appropriate hardware and software configured for wired and/or wireless communication over network 160. The merchant device 120 includes one or more merchant interface applications 122, which may be used by a merchant to contact a user over the network 160. In one implementation, the merchant interface application 122 comprises a software program, such as a graphical user interface (GUI), executable by a processor that is configured to interface and communicate with the one or more service provider servers 180 via the network 160. The merchant interface application enables the merchant to access a service provider website and communicate with service provider server 180, such as to convey and receive information regarding goods/services.

The merchant device 120, in various embodiments, may include one or more other applications 124 to provide additional features to the merchant. For example, these other applications 124 may include security applications for implementing client-side security features, programmatic client applications for interfacing with appropriate application programming interfaces (APIs) over the network 160 or various other types of generally known programs and/or applications.

The merchant device 120, in one embodiment, may include at least one network interface component (NIC) 128 adapted to communicate with the network 160. In various examples, the network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The merchant device 120, in one embodiment, may include one or more identifiers 130, which may be implemented as operating system registry entries, cookies associated with the merchant interface application 122, identifiers associated with hardware of the merchant device 120, and/or various other appropriate identifiers. The identifier 130 may include attributes related to the merchant device 120, such as identification information (e.g., a system serial number, a location address, Global Positioning System (GPS) coordinates, a network identification number, etc.) and network information (e.g., network owner, network provider, network administrator, network security information, etc.). In various implementations, the identifier 130 may be passed with network traffic data and information to the service provider server 180, and the identifier 130 may be used by the service provider server 180 to associate one or more network transactions of a user with one or more particular user accounts maintained by the service provider server 180.

Merchant device 120 may be maintained by one or more service providers (e.g., merchant sites, auction site, marketplaces, social networking sites, etc.) offering various items, such as products and/or services, through stores created through the service provider or their websites. Merchant device 120 may be in communication with a merchant server capable of handling various on-line transactions. The merchant (which could be any representative or employee of the merchant) can process online transactions from consumers making purchases through the merchant site from user devices. Merchant device 120 may include purchase application 132 for offering products/services for purchase. Merchant device 120 may also include Web pages or electronic documents 134 that can be accessed on the Internet.

Service provider server 180 may be maintained, for example, by an online payment service provider, which may provide processing for online financial and information transactions on behalf of a user with a merchant. In this regard, service provider server 180 includes one or more processing applications 182 which may be configured to interact with a user device over network 160 to facilitate sending payments from a user to the merchant. In one example, the service provider server 180 may be provided by PayPal®, Inc. of San Jose, Calif., USA.

Service provider server 180 also maintains an account database 184 for storing a plurality of user and merchant accounts in an account database, including one or more merchants or sellers associated with merchant device 120. Each account may include account information associated with consumers, merchants, and funding sources, such as credit card companies. For example, the account information may include identity information of users and merchants, such as one or more full names, business names, street addresses, email addresses and phone numbers, website addresses (URLs), or other types of financial information, which may be used to facilitate online transactions between users and merchants. Merchant account information may also include customer ID, and information associated with the merchant URL (e.g., items for purchase and corresponding price, terms and conditions, payment solutions, etc.).

The service provider server 180, in various embodiments, may include at least one network interface component (NIC) 186 adapted to communicate with the network 160 including the merchant interface application 122 of the merchant device 120. In various implementations, the network interface component 186 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The service provider server 180, in various embodiments, also includes a Web crawler application 188, such as that provided by 80 legs. The Web crawler 188 searches for electronic documents or Web pages (e.g., electronic documents 134) distributed on one or more computers connected to network 160 (e.g., merchant device 120), and retrieves the electronic documents and associated data.

Web crawler 188 is suitably configured to download Web pages from the network 160 using well known protocols such as HTML, XML, IP, and other applicable technologies. Web crawler 188 provides and analyzes downloaded Web pages (and possibly descriptive data, characterization data, or metadata related to the downloaded Web pages). In some embodiments, Web crawler 188 may be configured to analyze the downloaded Web pages in an appropriate manner to obtain and extract relevant information about the downloaded Web pages. The retrieved documents are processed to find any linked document address specifications contained in the retrieved documents. In certain embodiments, Web crawler 188 retrieves a URL from a database, processes the URL, and continues to process URLs until none are left.

Web crawler 188 may analyze and process content included in a Web page, the URL of the Web page, anchor text (i.e., the visible text associated with a hyperlink on the Web page) of outgoing links on the Web page, the URLs of outgoing links on the Web page, and the like. Web crawler 188 may send Web pages (and possibly descriptive data, characterization data, or metadata related to the Web pages) to an indexer for further processing.

The indexer is a computer program that maintains an index of electronic documents. The index may be similar to the index in a book, and can contain reference information and pointers to corresponding electronic documents to which the reference information applies. For example, the index may include keywords, and for each keyword a list of addresses. Each address can be used to locate a document that includes the keyword. The index may also include information other than keywords used within the electronic documents. For example, the index may include subject headings or category names, even when the literal subject heading or category name is not included within the electronic document. The type of information stored in the index depends upon the complexity of the indexer, which may analyze the contents of the electronic document and store the results of the analysis.

In certain embodiments, the service provider server 180 also includes a log file 190. The log file 190 contains a plurality of entries that each represents a document that is to be visited or that was already visited by the Web crawler 188. In one embodiment, each entry in the log file 190 contains the URL of the document to be processed, a time stamp indicating when the document was retrieved, a status data that is marked when the entry is processed, an error code data that indicates any errors encountered during processing, etc. One of ordinary skill in the art will appreciate that additional fields can be added to the data entries as may be required by the particular application.

The service provider server 180, in various embodiments, further includes a URL scoring module 192. The URL scoring module 192 is suitably configured to assign a score to a seller URL indicating the quality of the site, e.g., whether the site is “high risk,” “low risk,” etc. In some embodiments, the URL scoring module 192 provides a score indicating the likelihood that the merchant is planning on canceling the relationship or partnership with the service provider. For example, the URL scoring module 192 scores certain variables, which each indicate a probability that the merchant is interested in cutting ties with the service provider. These variables include, without limitation, what payment options are displayed (e.g., Does the merchant take PayPal, Google Check Out, AllPay, etc.?), where the different payment options are displayed (e.g., On the side bar, near the bottom of the page, etc.), and the prominence of the payment option (e.g., How big is the display?). In one embodiment, URL scoring module 192 processes the individual variables with a suitable algorithm or function to output individual scores. In another embodiment, URL scoring module 192 processes the variables together using a suitable algorithm to output a single score.

In various embodiments, machine learning and training may be utilized to generate models utilized by the system 100. Machine learning involves algorithms or techniques that enable a computer to learn from data. Machine learning includes a process of training a computer algorithm with test data. The algorithm is trained with known inputs and learns these patterns through one or more statistical methods. The algorithm can then properly classify new input based on the inputs it has seen during training. The algorithm must be able to perform accurately on new, unseen examples after having trained on a learning data set.

In this regard, a training set in the present disclosure includes a set of example Web pages used for generating the model. The training set contains Web pages that have been classified such that the set contains both examples of desired pages (e.g., pages that display the desired payment option prominently and do not include competitor payment options) and examples of non-desired pages (e.g., pages that hide the desired payment option among more prominently displayed payment options). The algorithm is trained to identify and score data to indicate a risk that a seller is likely to terminate the services of a service provider.

The service provider server 180 may also automatically monitor seller integration with the service or payment provider. For example, if a seller is not properly integrated with the payment provider, a consumer purchasing from the seller site, thinking that a purchase was made properly through the payment provider, may find out that the purchase is not protected by the payment provider. This can lead to the buyer refusing to use the payment provider on other transactions with the seller and other authorized, properly integrated sellers.

The service provider server 180, in various embodiments, may include one or more databases 194 (e.g., internal or external) for storing and tracking information related to users and/or merchants. The database 194 may store, for example, address data for communicating with a user device. The address data may include data for communicating a text message to a user device, an e-mail address at which messages are receivable by a user device, or any other manner for communicating with a user device. Moreover, service provider server 180 may include computer executable instructions that are operative to cause the server 180 to generate message content appropriate for messages to be communicated to a user device.

In certain embodiments, the system 100 is used to determine which URLs sellers are using to sell their goods and services. There is a growing trend of risk associated with email payments and shell sites. Sellers who are not providing accurate URL or contact information to a service provider can be queued for further review. Information extracted from a seller site can be reviewed to determine if the seller is being truthful about their industry and experience.

The extracted content can also be used to detect fraud on the part of the seller, such as changes in the owner of the site, embellished feedback on the site, preselling items, using small print in the Terms and Conditions to deceive the elderly or näive buyers, using fake credentials, under market selling, “unknown” or fake merchandise being sold, and changing merchandise. In some embodiments, the Web crawler 188 extracts information from the Terms and Conditions on a seller site. This information includes, for example, the charging type (e.g., every 30 days), the charging amount (e.g., $88), the text price of an item, if a trial offer is provided, how the trial offer is, if a phone number is found, and regular prices of items.

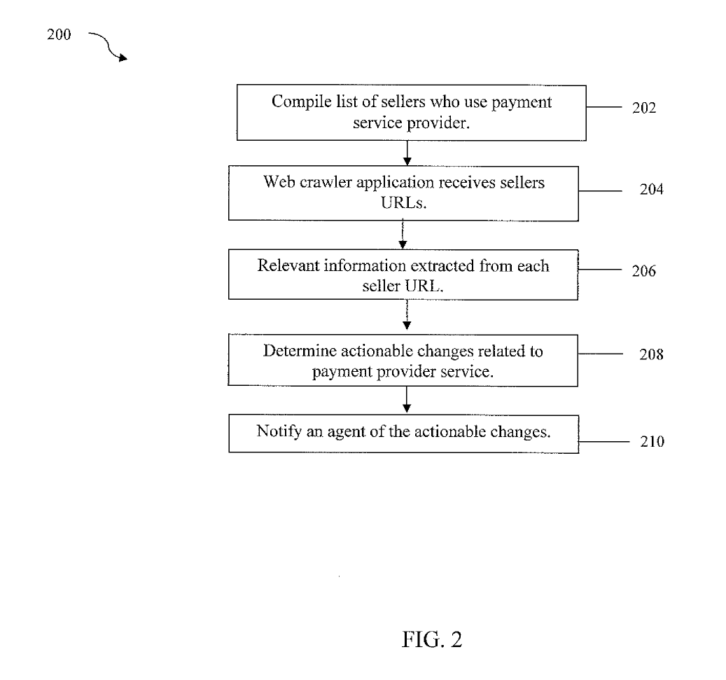

Referring now to FIG. 2, a method 200 of monitoring a merchant URL according to an embodiment of the present disclosure is illustrated. At step 202, the service provider collects or compiles a list of sellers (along with their respective URLs) who use their service to collect payment. The service provider may be, for example, the payment provider PayPal®, Inc. of San Jose, Calif. In one embodiment, this data is stored in account database 184.

At step 204, the sellers' URLs are received by Web crawler application 188. The Web crawler 188 is invoked by passing it one or more starting URLs. The starting URLs serve as seeds, instructing the Web crawler 188 where to begin its Web crawling process. A starting URL can be a universal naming convention (UNC) directory, a UNC path to a file, or an HTTP path to a URL. For ease of description, the Web crawling process is described below in the context of processing one Web page at a time. It should be understood, however, that the Web crawler 188 may process any number of Web pages and any number of URLs in a concurrent or parallel manner using equivalent techniques.

The Web crawler 188 retrieves a URL from the database 184 and uses the URL to retrieve the electronic document at the address specified by the URL. The Web crawler 188 picks up the content on the seller website. Content of a Web page refers, for example, to HTML content which the Web server returned when an http request was made to a server with a URL (or URI).

In some embodiments, the Web crawler 188 uses the access method specified by the URL to retrieve the electronic document. For example, if the access method is HTTP, the Web crawler 188 uses HTTP commands to retrieve the document. If the access method specified is FILE, the Web crawler 188 uses file system commands to retrieve the corresponding documents. The File Transfer Protocol (FTP) is another other well known access method that the Web crawler 188 may use to retrieve a document. Other access protocols, such as XML, may also be used in conjunction with the present disclosure. In some embodiments, the Web crawler 188 also maintains a history map, which contains an ongoing list of all URLs that have been searched during the current Web crawl and previous Web crawls.

After retrieving an electronic document, the Web crawler 188 removes extraneous data (e.g., formatting information), aggregates, parses, and indexes the electronic document and returns a list of relevant text and properties. At step 206, Web crawler 188 scrapes or extracts relevant information from the electronic document. Relevant information includes, but is not limited to, seller industry, age of website, products or services sold and corresponding prices, owner of website, terms and conditions, number of links, number of ads on homepage, number of pages on the website, refund and return policy information, contact information, available shipping options, payment options, popularity, etc. In one embodiment, the relevant information includes information related to payment or funding sources on the site (e.g., payment options and card types accepted, availability of coupon codes for checkout, security of checkout page, availability of recurring billing/subscription service, accepted currency types, CPS priority risk, etc.).

At step 208, the server 180 determines actionable changes related to a payment provider service. Actionable changes include one or more of a change in site ownership, a change in site affiliation, a change in placement of payment options, a change in visibility of payment options, a change in the addition or deletion of payment options, a change in the volume or dollar amount of transactions by customers of the seller using the payment option. For example, actionable changes include the payment provider option moved to a less desirable placement or location on the site, visibility of the payment provider option reduced, one or more new funding sources added to the site, and the payment provider option deleted from the site.

Positive changes may also be monitored and reported to the service provider. Positive changes include deleting one or more competitor funding source options, reducing the placement and/or visibility of competitor funding source options, increasing the visibility and/or placement of the payment provider funding source option, seeing an increase of use, volume, or dollar amount of transactions using the payment provider option. The service provider may then contact or offer the seller additional features, thanks, etc., to solidify and possibly expand the relationship.

The monitoring for actionable changes may be automated so that seller sites are searched every week (or other time period) for changes. Reports may be created to show sellers with actionable changes. The reports may be filtered so that large merchants, which may already be monitored by an account manager, are not shown on the reports.

In one embodiment, the server 180 compares an old version of the relevant data (e.g., data stored from a previous Web crawl) to a new version of the relevant data (e.g., data obtained from a recent Web crawl). Server 180 determines if the relevant information was modified in some substantive manner. For example, Web crawler 188 determines if an actual substantive change was made to a Web page by comparing currently extracted data with previously stored extracted data.

In another embodiment, the current extracted data is input into a model (e.g., a model previously trained with known data from seller websites). URL scoring module 192 takes the data and uses it in the model to calculate a score for the seller site. In certain embodiments, internal data (i.e., data from the service provider such as the number and dollar amount of transactions performed by the seller on the seller site) is also input into the model. The model outputs a score (e.g., 0-1000) that indicates the probability that the seller is canceling the relationship or partnership with the payment provider. For example, the higher the score, the greater the chance that the seller will cut ties with the payment provider.

In some embodiments, a determination of whether the probability exceeds or crosses a certain threshold is made. The threshold may be associated with the level of certainty that the seller is going to leave the payment provider. If the probability exceeds the threshold, the relationship between the payment provider and the seller may be determined to be critical.

At step 210, if an actionable change is determined (e.g., the score exceeds the threshold), the server 180 notifies an agent of the payment provider of the actionable change. The payment provider may be notified, for example, when one or more of the following are detected: the payment provider option is moved to a less desirable placement or location on the site, visibility of the payment provider option is reduced, such as by decreasing its size, color, or brightness, one or more new funding sources are added to the site, especially if those are given a more desirable placement and/or visibility than the payment provider, etc.

Once the payment provider is notified, the payment provider may take any necessary action, such as contacting the seller and asking if there have been any issues with the payment provider service, if there is anything the seller would want to see from the payment provider, such as an improved payment flow, lower fees, etc. Regardless, the payment provider may engage the seller in a conversation to fix any issues the seller may have before the seller reaches a point where any issues are unfixable and the seller simply ends the relationship with the payment provider.

By monitoring a seller's URL, such as using Web-crawling technology, valuable information may be obtained by a service provider. The system may continuously monitor a seller site and notify or otherwise alert the service provider of actionable changes. The methods and systems described herein infer or predict the likelihood that a seller is planning to leave a service provider based on the content of the seller website. The methods typically include learning correlations between features of Web page content and applying predictive models and classification algorithms to predict whether the seller plans on ending its relationship with the service provider. The methods have the advantage of being less invasive and invoking less privacy issues than other monitoring techniques because they rely on the available content of a Web page.

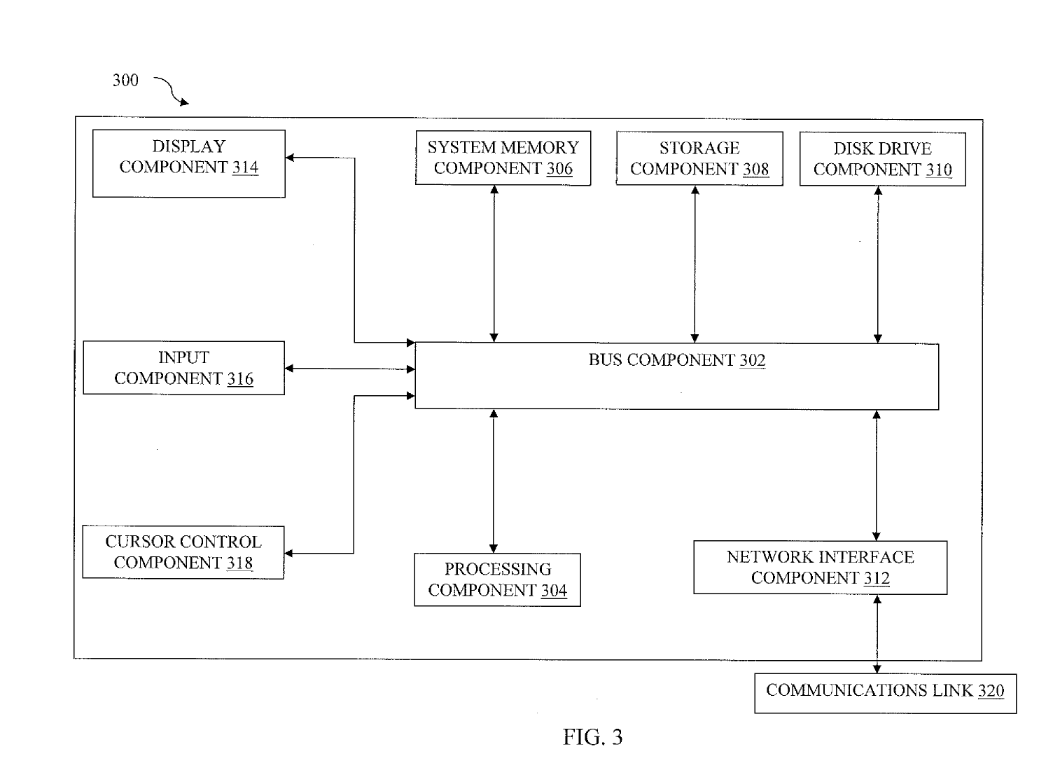

Referring now to FIG. 3, a block diagram of a system 300 is illustrated suitable for implementing embodiments of the present disclosure, including merchant device 120 and service provider server 180. System 300, such as part of a cell phone, a tablet, a personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 314 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to provide seller URLs to a Web crawler application, extract content from seller sites, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 160 of FIG. 1, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In view of the present disclosure, it will be appreciated that various methods and systems have been described according to one or more embodiments for monitoring seller URLs. Although various components and steps have been described herein as being associated with merchant device 120 and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure. For example, although transactions have been described according to one or more embodiments, it should be understood that the present disclosure may also apply to transactions where requests for information, requests for access, or requests to perform certain other transactions may be involved.

Having thus described embodiments of the disclosure, persons of ordinary skill in the art will recognize that changes may be made in form and detail without departing from the scope of the disclosure. Thus the disclosure is limited only by the claims.

What is claimed is:

1. A system comprising:
a memory device storing merchant account information, wherein the information comprises a merchant URL associated with a merchant site; and
one or more processors in communication with the memory device and operable to:
receive a merchant URL;
extract content from a Web page associated with the merchant URL; and
determine actionable changes related to a payment provider service on the merchant site.

2. The system of claim 1, wherein the one or more processors is further operable to score the merchant site.

3. The system of claim 1, wherein the one or more processors is further operable to notify an agent of the actionable changes.

4. The system of claim 1, wherein the actionable changes comprise one or more of a change in site ownership, a change in site affiliation, a change in placement of payment options, a change in visibility of payment options, a change in the addition or deletion of payment options, or a change in the volume or dollar amount of transactions by customers of the merchant using the payment option.

5. The system of claim 4, wherein the actionable changes comprise one or more of a payment provider option moved to a less desirable placement or location on the site, visibility of the payment provider option reduced, one or more new funding sources added to the site, or the payment provider option deleted from the site.

6. The system of claim 4, wherein the actionable changes comprises one or more of deleting one or more competitor funding source options, reducing a placement and/or visibility of competitor funding source options, increasing a visibility and/or placement of a payment provider funding source option, or seeing an increase of use, volume, or dollar amount of transactions using the payment provider option.

7. The system of claim 1, wherein the one or more processors is further operable to compare previously extracted content to currently extracted content to determine actionable changes.

8. The system of claim 1, wherein the one or more processors is further operable to input the extracted content into a model and provide a score to determine actionable changes.

9. The system of claim 8, wherein the score indicates a probability that the merchant will cancel its relationship with the payment provider.

10. A non-transitory machine-readable medium comprising a plurality of machine-readable instructions which when executed by one or more processors of a server are adapted to cause the one or more processors to perform a method comprising:
receiving a merchant URL associated with a merchant site;
extracting content from a Web page associated with the merchant URL; and
determining actionable changes related to a payment provider service on the merchant site.

11. The non-transitory machine-readable medium of claim 10, wherein the method further comprises scoring the merchant site.

12. The non-transitory machine-readable medium of claim 10, wherein the method further comprising notifying an agent of the actionable changes.

13. The non-transitory machine-readable medium of claim 10, wherein the actionable changes comprise one or more of a change in site ownership, a change in site affiliation, a change in placement of payment options, a change in visibility of payment options, a change in the addition or deletion of payment options, or a change in the volume or dollar amount of transactions by customers of the merchant using the payment option.

14. The non-transitory machine-readable medium of claim 13, wherein the actionable changes comprise one or more of a payment provider option moved to a less desirable placement or location on the site, visibility of the payment provider option reduced, one or more new funding sources added to the site, or the payment provider option deleted from the site.

15. The non-transitory machine-readable medium of claim 13, wherein the actionable changes comprises one or more of deleting one or more competitor funding source options, reducing a placement and/or visibility of competitor funding source options, increasing a visibility and/or placement of a payment provider funding source option, or seeing an increase of use, volume, or dollar amount of transactions using the payment provider option.

16. A method of monitoring a merchant URL, comprising:
receiving a merchant URL associated with a merchant site, by a processor of a payment provider;
extracting content from a Web page associated with the merchant URL;
determining, by the processor, actionable changes related to a payment provider service on the merchant site; and
notifying an agent of the actionable changes.

17. The method of claim 16, further comprising scoring the merchant site.

18. The method of claim 16, wherein the actionable changes comprise one or more of a change in site ownership, a change in site affiliation, a change in placement of payment options, a change in visibility of payment options, a change in the addition or deletion of payment options, or a change in the volume or dollar amount of transactions by customers of the merchant using the payment option.

19. The method of claim 18, wherein the actionable changes comprise one or more of a payment provider option moved to a less desirable placement or location on the site, visibility of the payment provider option reduced, one or more new funding sources added to the site, the payment provider option deleted from the site, deleting one or more competitor funding source options, reducing a placement and/or visibility of competitor funding source options, increasing a visibility and/or placement of a payment provider funding source option, or seeing an increase of use, volume, or dollar amount of transactions using the payment provider option.

20. The method of claim 18, wherein determining actionable changes comprises comparing previously extracted content to currently extracted content to determine actionable changes, or inputting the extracted content into a model and providing a score.
